(19) United States
(12) Patent Application Publication
(10) Pub. No.: US 2009/0045952 A1
(43) Pub. Date: Feb. 19, 2009

(54) Operating & controlling a security system by mobile phone

(76) Inventor: Habib Bahari, Rockville, MD (US)

Correspondence Address: HABIB BAHARI, 3810 TERRAWOOD COURT, ROCKVILLE, MD, 20853, US

(21) Appl. No.: 12/231,633

(22) Filed: Sep. 5, 2008

(51) Int. Cl. G08B 13/00; H04M 11/04

(52) U.S. Cl. 340/541; 455/404.1

(57) ABSTRACT

An operating and controlling system is disclosed to monitor and protect various premises. The premises may include residential, commercial, automobile, boat, airplane or any other property that is to be protected by a security system. A Hand Held Mobile Phone (HHMP) manages and controls the security system through a two way wireless multimedia communication between the security device located at the premises and the HHMP remotely located worldwide.

### BACKGROUND OF THE INVENTION

1. Field of Invention

The present invention relates generally to a security system and method of operating its control panel by a HHMP, which gives ability to operate, monitor and control every function of the security system control panel as far as the wireless network can receive signals nationally or internationally.

2. Discussion of the prior Art

Security system installations frequently place video camera and security monitoring sensors, such as intrusion sensors and motion detectors through and around the perimeter of a protected space to detect the presence of an intruder. The status of the security system and the video camera recordings are frequently available for review within the protected space, such as on a security console and video display, or wireless transmitted to a portable monitor within limited distance from the protected premises. Typically a central security station at a distance location can also review the status of the complete security system and camera recordings by communications over a telephone line and/or cable network and/or internet connections.

However in many present residential homes, commercial properties, automobiles, boats, airplanes, or other properties protected by a security system, one can not review status or view video images and operate the security system to ones satisfaction far away from the protected properties. This restriction will cause time and money and will not allow the property owner to operate the security system or detect any burglary in process with lease amount of time and effort.

### SUMMARY OF THE INVENTION

The present invention provides a security system and method having a portable control panel through a HHMP which gives access to (manage, operate, and control) of a security system control panel protecting premises, such as automobiles, airplanes, boats, residential or commercial properties any time and anywhere within wireless network reception of the HHMP nationally or internationally. The security system incorporates a security control panel, security sensors such as intrusion sensors or motion sensors, video camera inside and outside protected premises, an advance version of HHMP with possibility of having a clear high resolution monitor such as a LCD (liquid crystal display) monitor, video, or texting/numeric buttons capabilities. Any advancement to functionality of HHMP other than what is mentioned which advances the managing, operating, or controlling the security system is part of this invention which includes but is not limited to;

The HHMP as portable control panel can receive video images signals from inside or outside of the protected premises and display them for viewing at any time the security system is on.

The HHMP as portable control panel can receive ring tone signals by way of dial-up from the main control panel if there is intrusion interference with the security system sensors or false alarm, then HHMP can view the protected premises and transmits commands accordingly by way of numerical code system or texting code system, such as turn off and then turn on command in a case of false alarm which happens so often on protected vehicles.

The HHMP as portable control panel can provide status of all the sensors within the security system and provide information such as normal sensors or malfunctioning sensors for viewing.

### BRIEF DESCRIPTION OF THE DRAWINGS

FIG. 1: Illustrates a security system for a premises such as automobiles, boats, airplanes, residential, commercial properties, or any other premises that can be protected by a security system that typically comprises a security system control panel provided at a central accessible location, such as just inside the front entrance of a property or inside a compartment in a moving vehicle, security sensors, and security video cameras.

FIG. 2: Illustrates a hand held wireless mobile phone with advance video monitor/display, numerical and texting buttons.

### DETAILED DESCRIPTION OF THE INVENTION

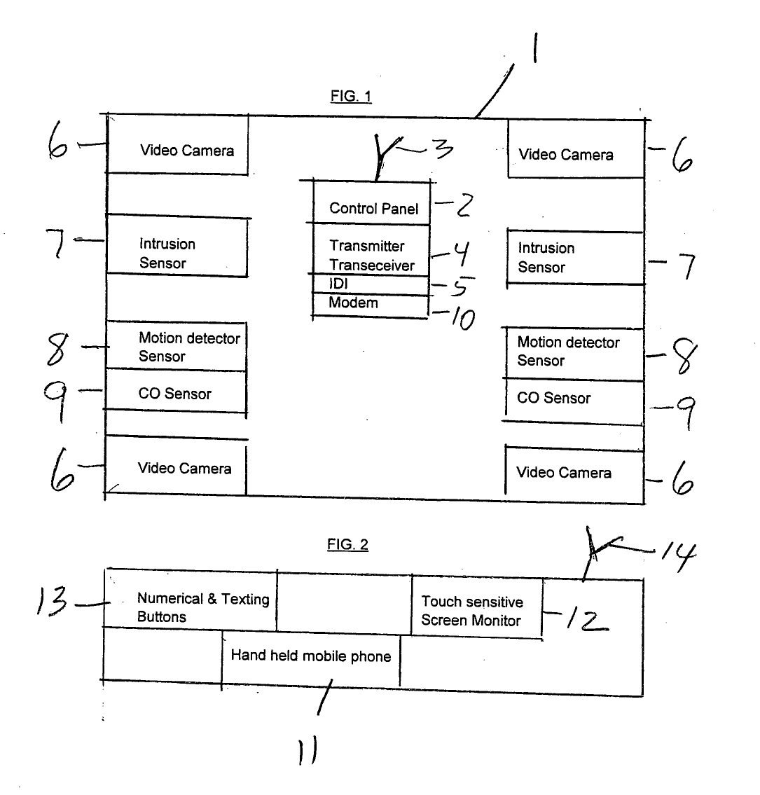

FIG. 1 illustrates a security system for premises such as residential or commercial properties, automobiles, boats, airplanes, any other properties that can be protected by a security system (1). that typically comprises a security system control panel with dial-up capability (2) to the HHMP device (11) provided a central accessible location, such as just inside the front entrance of a property or inside a compartment in a moving vehicle by the security alarm system. The control panel (2) provides a property owner with a display (5) of information on the complete status of the security system of the premises, such as a display of pertinent parameters and conditions of the security system of the premises, and also provides a display of video images provided by the security system video cameras (6) inside the secured premises.

The security control panel also enables a person to manage and control operation of the security system, such as arming or disarming of the security system by entry of a proper security code and of specific commands. The control panel might include a IDI display (imaging display interface) (5) to enable a user to view the status of the security alarm system and also to enter data into, access, and control the security system.

The security system control panel also includes a transmitter or transceiver (4) and antenna (3) to transmit or receive data back and forth by the hand held mobile phone HHMP (FIG. 2) and the security system might be a wireless system which enables the communications between sensors and the control panel.

A typical residential, commercial property, automobile, boat, airplane, and any other premises security system also includes a plurality of intrusion security sensors (7) mounted at doors and window to detect any intrusions thereat and motion/occupancy sensors (8) mounted at strategic locations in the premises to detect the presence of a person thereat which are connected by security system wiring to the security system control panel. A typical security system might also include one or more CO sensors (10) and smoke or fire sensors (9) mounted at strategic locations in the premises to detect any of those conditions in the premises, with those sensors also being connected by security system wiring to the security system control panel. The security system control panel monitors signals from the security system sensors and video cameras to determine the status of the security system.

A typical residential, commercial property, automobile, boat, airplane, and other premises security system might also include a modem (10) and a telephone line or cable connection to allow bi-directional data communications over telephone lines and/or a cable system and/or the internet.

The transmitter or transceiver (4) allows the security system to transmit and receive data to Enable the property owner to review the status of the security system, and also to review video Images provided by the security system inside and outside video cameras.

The present invention provides a security system and method for a protected space such as a residential, commercial property, automobile, boat, airplane, and any other premises that transmits a wireless transmission to a wireless hand held mobile phone (11) as illustrated in FIG. 2, that includes a video display possible touch screen capabilities (12), numerical/texting buttons (13), and antenna (14).

For instance a hand held mobile phone within range of receiving signals domain in form of video imaging, texting, or numerical coding can transmit and receive signals from the security system control panel with wireless dial-up capabilities. This will allow the property owner to see the status of the security system and to manage, control, and operate the system through his HHMP away from the security system control panel regardless of distance.

Having thus described my invention. What I claim as new and desire to secure by Letters Patent is:

1- A security system including a control panel with dial-up capabilities, security sensors for Detecting security/alarm events in the protected spaces, and a wireless hand held mobile phone for transmitting and receiving data on the status of the security system;
A hand held wireless mobile phone an advance version to include touch sensitive monitor screen, possible in LCD, dial-up numeric/or alphabetic texting buttons to be able to transmit or receive data from the security system control panel, such that the mobile phone can be held in some ones pocket, purse, attached to a belt, or mounted on a secured location;
A security system with a control panel capable of dialing to HHMP in case of any intrusions detected by its sensors or video cameras, false alarm, or general status of the security system;
A security system with hand held mobile phone as a portable wireless control panel capable of receiving ring tone from main control panel to view status of the security system or to view video images from the security system video cameras inside or outside of the protested premises;
A security system with hand held mobile phone as a portable wireless control panel capable of transmitting by dial-up various commands to the main control panel, commands are sent by numeric codes or texting which can be transmitted into commands inside the main control panel, some of the commands are turn on, turn off, display images, view video images, and sensors status; and
A security system with hand held mobile phone (portable control panel) and a main control panel with dial-up capability is able to transmit or receive back and forth through wireless telephone network any where nationally or inter nationally.

2- The security system of claim 1, where the security system includes at least one security video camera for taking video frames and hand held wireless mobile phone with a capable of displaying the video frames taken by a least one security video camera.

3- The security system of claim 1, wherein a user name ID and Password must be enter for the security system HHMP and main control panel transmit and receive data.

4- The security system of claim 1, wherein a security system video camera is positioned to view area with obscured visibility, and the wireless hand held mobile phone monitor and display are used to view the areas with obscured visibility.

5- The security system of claim 1, wherein the security system includes a modem and a telephone line or cable connection to allow bi-directional data communications over the telephone line or cable connection.
